(19) United States
(12) Patent Application Publication
(10) Pub. No.: US 2006/0271855 A1
(43) Pub. Date: Nov. 30, 2006

(54) Operating system shell management of video files

(75) Inventors: Michael J. Patten, Sammamish, WA (US); Christopher Michael Hugill, Woodinville, WA (US); Ian Cameron Mercer, Sammamish, WA (US); Randolph Bruce Oakley, Bellevue, WA (US); Richard J. Qian, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/139,119

(22) Filed: May 27, 2005

(51) Int. Cl. G11B 27/00

(52) U.S. Cl. 715/723

(57) ABSTRACT

Managing digital video files on a computer. A media file system object stores metadata representative of a video clip defined from a video file to be managed. A shell interface associated with an operating system of the computer exposes the object to enable management of the video clip directly via the operating system.

### BACKGROUND

As the popularity of video cameras and personal computers grow, both professional and amateur videographers naturally look to the use of their computers for managing their video footage. Several video editing software programs are currently available on the market. In general, these programs all follow similar processes, namely, transferring recorded or live video, either in digital or analog format, to a computer disk drive and then performing operations on the resultant digital video file from within the particular video editing program being used. Conventional video editing programs permit users to build storyboards, divide video files into segments (i.e., clips), arrange and edit clips, add audio, and the like. Moreover, after editing, conventional video editing software programs permit users to save and store video files to their computers or portable storage media for further operations such as playback, posting on a website, and sending to others by e-mail.

These conventional software editing tools are still relatively cumbersome and make it difficult for many users to easily and effectively manage home video on their personal computers. For example, all of the operations described above must be performed within a video editing software program. This tends to unduly complicate desired tasks such as searching for particular video file content, trimming video, e-mailing short video clips, and so forth. In the example of sending video by e-mail, conventional software programs require the user to first perform multiple, time-consuming editing steps before the user can attach and send the video.

With respect to video editing, conventional methods fail to maintain the integrity of the original video files or require working from copies of the original files. Presently available video software programs require, for example, dividing a single video file into new, separate video files for displaying and editing segments or clips of video. Breaking a video file into a separate file for each clip has several limitations and can impact the quality of the video. In addition, performing file-based operations on individual clips can be very resource intensive and lengthy.

Unlike most media objects, which can be tied to a single point in time (e.g., the date and time a photograph was taken or the day a song was first released), a video clip necessarily spans a range of time. Moreover, the video file from which the clip was taken usually spans a much larger range of time (sometimes as much as an entire year or more). The inability of conventional video editing software programs to treat video clips as individual entities further encumbers the management of video files on a computer.

### SUMMARY OF THE INVENTION

Embodiments of the invention overcome one or more deficiencies in the prior art by permitting users to treat video clips as individual entities. In doing so, the accessibility of the user's video content is improved. One embodiment of the invention represents video clips in a computer operating system's shell. Users can transfer video content to a computer and then manage, render, search, and share the content using the computer. In addition, the user can easily define and edit video clips to create new video “memories” on the computer. Advantageously, aspects of the invention allow users to essentially manipulate video clips in much the same manner and as easily as other media objects without altering their video files and without using separate video editing software.

Computer-readable media having computer-executable instructions for performing a method of managing video clips embody further aspects of the invention.

Alternatively, embodiments of the invention may comprise various other methods and apparatuses.

Other features will be in part apparent and in part pointed out hereinafter.

### BRIEF DESCRIPTION OF THE DRAWINGS

FIG. 1 illustrates an exemplary relationship between a video file and video clips according to one embodiment of the invention.

FIG. 2 is an exemplary flow diagram illustrates processes executed by a computer according to one embodiment of the invention.

FIG. 3 illustrates an exemplary format of an ASF top level object according to one embodiment of the invention.

FIG. 4A illustrates an exemplary structure of an ASF file according to one embodiment of the invention.

FIGS. 4B and 4C illustrate the exemplary structure of the ASF file of FIG. 4 indicating the location of a TOC object according to embodiments of the invention.

FIG. 5 illustrates an exemplary layout of the TOC object according to one embodiment of the invention.

FIG. 6A illustrates an exemplary structure of the TOC object according to one embodiment of the invention.

FIG. 6B illustrates an exemplary Table of Contents field of the TOC object according to one embodiment of the invention.

FIG. 6C illustrates an exemplary Entry Lists field of the Table of Contents according to one embodiment of the invention.

FIG. 6D illustrates an exemplary Entry field of the Entry Lists according to one embodiment of the invention.

FIG. 7 is a block diagram illustrating an exemplary embodiment of a suitable computing system environment in which one embodiment of the invention may be implemented.

Corresponding reference characters indicate corresponding parts throughout the drawings.

### DETAILED DESCRIPTION OF THE INVENTION

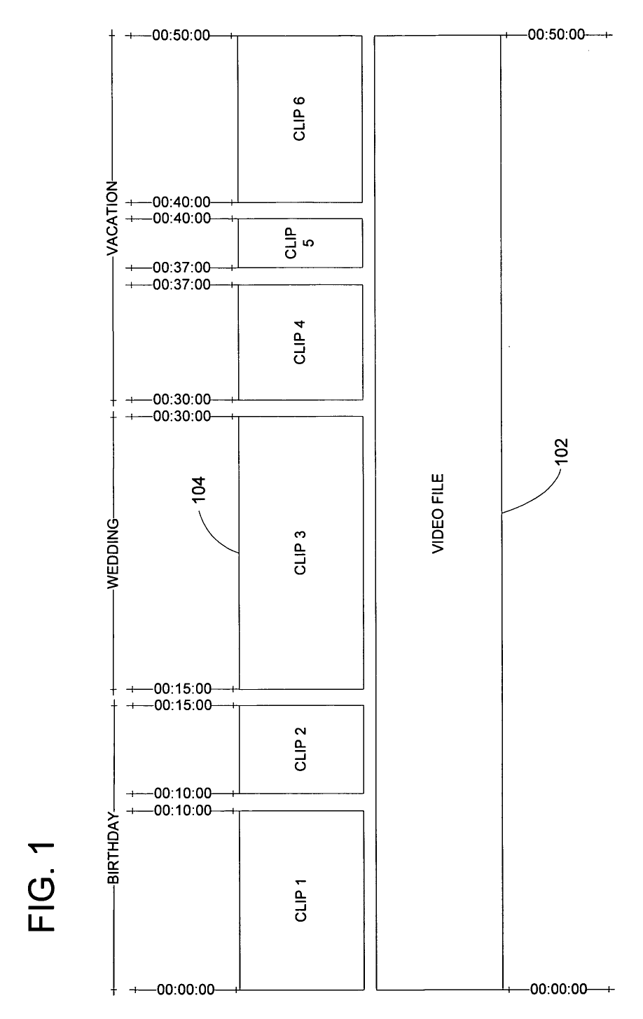

Referring now to the drawings, FIG. 1 illustrates an exemplary relationship between a video file 102 and video clips 104. The video file 102 is a single file representing one or more video clips 104. The video file 102 results from transferring recorded or live video, either in digital or analog format, to a storage medium such as a computer hard drive. When a user captures video content from a digital device (e.g., a digital camcorder), the video is captured to a single video file 102.

Each video clip 104 represents a portion or segment of video file 102. On a single videotape, for example, the user may have recorded multiple events. Within each recorded event, there may be one or more discrete scenes. Depending on how video clips 104 are defined, each video clip 104 is usually composed of a discrete scene. In the example of FIG. 1, a user recorded video content from a birthday, a wedding, and a vacation. One or more scenes may be found within each of these three key events. Each scene is represented as a video clip 104. Aspects of the invention permit the user to easily view and manage each of the three events and their specific scenes.

As described in greater detail below, a user's video “memories,” in the form of clips 104, may be stored and represented in the computer's operating system without one-to-one correspondence between a so-called “memory” and a physical file in the computer's file system. Representing video clips 104 in a computer operating system's shell according to the invention permits users to transfer video content to a computer and then manage, render, search, and share the content using the computer. In addition, the user can easily define and edit video clips 104 to create new video “memories” on the computer. Advantageously, aspects of the invention allow users to essentially manipulate video clips 104 in much the same manner and as easily as other media objects without altering their video files 102 and without using separate video editing software. Allowing users to bypass the editing process entirely for many common scenarios expands the number of users who can effectively manage video content on their computers.

As an example, most video content is recorded onto videotape. A capture process known to those skilled in the art may be used to capture and transfer the video content from the tape to a digital file, i.e., video file 102, for use on the computer. A standard video tape records 60 minutes of video. On average, a typical user captures between 20 and 40 minutes of content per tape. Because the user is capturing from tape, this is a real-time process and can be time-consuming. As such, many users have avoided capturing video to digital video files on their computers. Advantageously, embodiments of the invention simplify management of video content so that users can more readily realize the benefits of capturing their videos to the computer.

For tape devices, the video content is captured to a single video file 102. In this instance, video clips 104 may be defined every time the videographer started recording video. For long video clips 104, additional scene detection techniques based on the video content may be used to further define video clips 104. For example, a user records 20 minutes of her daughter's birthday party without ever pressing the stop record button during the take. Aspects of the invention permit analyzing the video based on this contiguous content to break the content into scenes for presenting a richer view of the event. Moreover, the user can more easily recognize, for example, when her daughter opened presents or blew out the birthday candles.

When legacy analog content is captured to a computer, perhaps using an analog to digital video converter, video file 102 is constructed as one long scene. Video analysis aspects of the invention permit determining logical start and stop times that were on the original tape to identify clips 104.

In the alternative, users may wish to capture video content from a solid state device, such as a digital camera. In this instance, capturing the video content comprises a transfer or synchronization from the solid state device. Known solid state digital camcorders and the like record a single file each time the videographer starts and stops the recording process. Like tape capture, scene analysis may be desired to analyze the content to identify more granular clips as appropriate.

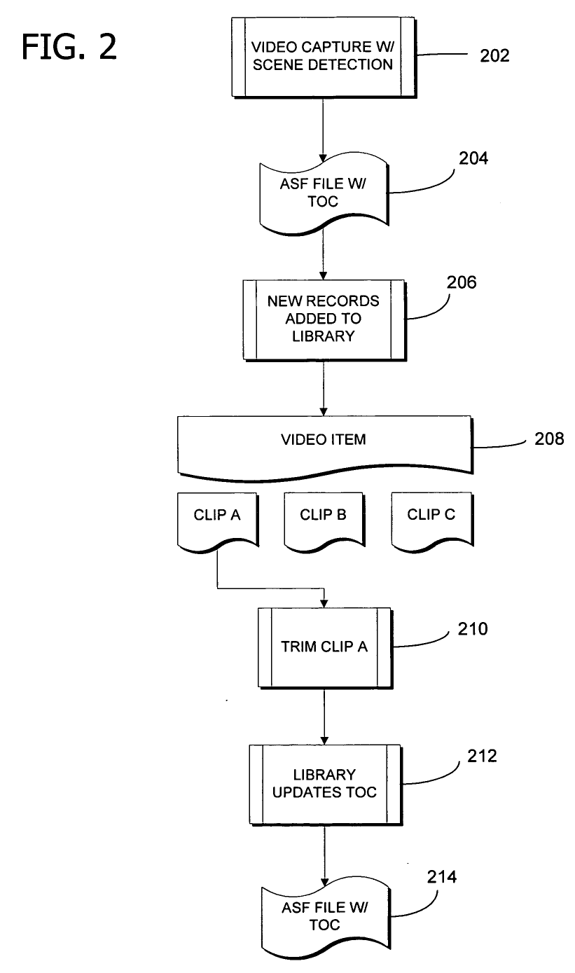

Referring now to FIG. 2, an exemplary flow diagram illustrates processes executed by a computer according to one embodiment of the invention. Beginning at 202, a user acquires a new video file 102 using, for example, a capture wizard. During capture, video file 102 is analyzed and scenes are detected.

The number of clips 104 in a particular video file 102 is based on the user's content and varies from video to video. The model differs slightly for video content captured from videotapes versus video content captured from solid state devices. TABLE I provides a comparison of video content captured from different sources:

TABLE I

| | | Files | | Likely |
|---|---|---|---|---|
| | | during | Scenes | Total |
| | Number of events | capture | detected | clips |
| Video | 2-3 events. Users typically fill the | 1 per | 45-60 | 60 |
| Tape | tape before performing capture, | tape | | |
| | which averages about 45 | | | |
| | minutes. Most users save the | | | |
| | tapes as their master backup. | | | |
| | Tapes cost $3-5 each. | | | |
| Solid | 1-2 events. Users can more | 5-15 | 5-20 | 40 (20 |
| State | easily download events from their | per | per | per |
| | devices and free storage spaces. | event | event | event) |
| | This event occurs more frequently | | | |
| | than video tapes. Each event is | | | |
| | typically 10-20 minutes. | | | |

Referring again to FIG. 2, a media file (i.e., video file 102) is written at 204 following capture. In one embodiment, the media file is written according to an Advanced Streaming Format (ASF) and includes a media file system object, designated TOC (Table of Contents). Aspects of the present invention relate to the TOC object, which contains records for each defined clip 104 with the video file 102. Features of the TOC object are described in greater detail below. In an alternative embodiment, the TOC information can be inserted into a file written according to another audio-video standard, such as Audio Video Interleave (AVI).

At 206 as shown in FIG. 2, the computer executes a file promoter to parse the TOC object in a video format (e.g., Windows Media Video) and creates a new video library record as well as a separate clip record for each clip 104. In other words, the capturing computer defines one or more video clips 104 from each of the video files 102 to be managed. In one embodiment, the operating system exposes a media library to the user, which stores the TOC object containing metadata assigned to represent the clip 104.

Continuing at 208, the operating system shell exposes each clip 104 via the TOC object, including the metadata. User-initiated tasks, such as playback, delete, trim, and combine, are registered for clips 104 at 210. In response, the computer writes changes to video clips 104 to the database. In particular, the shell detects the changes and updates the TOC object in the file header at 212, which results in a new ASF file with the TOC at 214. This ensures that the records and the TOC object are always in sync.

Exposing video clips 104 via the shell in a media library, for example, by use of the TOC object improves overall video workflow, including capture, organization, editing, movie creation, and sharing on disc, e-mail, or portable media center device. The same principles may be applied for exposing clips 104 in the shell interface of the computer's operating system for enabling users to view and manage video clips 104 directly in the operating system without having to open a separate application like a video editing tool. In addition, this maintains the integrity of video file 102 and refrains from separating the video clip 104 undesirably into separate video files 102 even when edited.

As described above, traditional approaches to displaying video clips 104 rely on a separate dedicated video application and/or breaking the video file 102 into separate video files 102 for each defined video clip 104. Unfortunately, breaking a video file 102 into separate files 102 for multiple clips 104 has several limitations and can impact the quality of the video. By representing video clips 104 as metadata in the shell, embodiments of the present invention enable operations to be performed on clips 104 almost instantaneously without any impact on video quality.

In contrast to known methods, operations on video clips 104 via the shell are non-destructive. Since video clips 104 are represented as metadata that the operating system understands, users can perform operations like trimming video clip 104 by setting new mark-in and mark-out locations. In this instance, trimming simply updates the metadata for the video clip 104. Users can adjust the mark-in and mark-out locations without impacting the original video source in video file 102. Trimmed video clips 104 can also be easily untrimmed by simply adjusting the mark-in and mark-out locations.

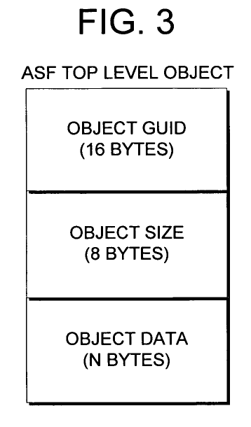

In one embodiment, the TOC, or Table of Contents, object comprises an ASF object for storing advanced index information and associated metadata. FIG. 3 illustrates the format of an ASF top level object. As shown, the format of the ASF top level object and, consequently, the TOC object of the invention, has an object GUID field of 16 bytes, an object size field of 8 bytes, and an object data field of N bytes. The value of the object size field is, for example, the sum of 24 bytes plus the size of the object data in bytes. Examples of advanced index information include table of contents, semantic indices, and story board. Examples of the associated metadata include entry-based textual description, cover arts, thumbnails, audiovisual DSP properties and cross references.

By analogy, most books contain a table of contents that gives the reader a hierarchical overview of the book contents and helps the reader to navigate through the pages quickly. Many books may also have a semantic index table to allow reverse lookup of the page numbers that are related to certain pre-selected keywords. In contrast, most existing multimedia files, such as WMV files, do not have such index information. To find an interesting scene in a typical video file 102, the user would have to manually browse through the entire file. Such task is often tedious and time-consuming, especially for large files. Therefore, it is desirable to add advanced indexing functionality to multimedia files, namely, video files 102.

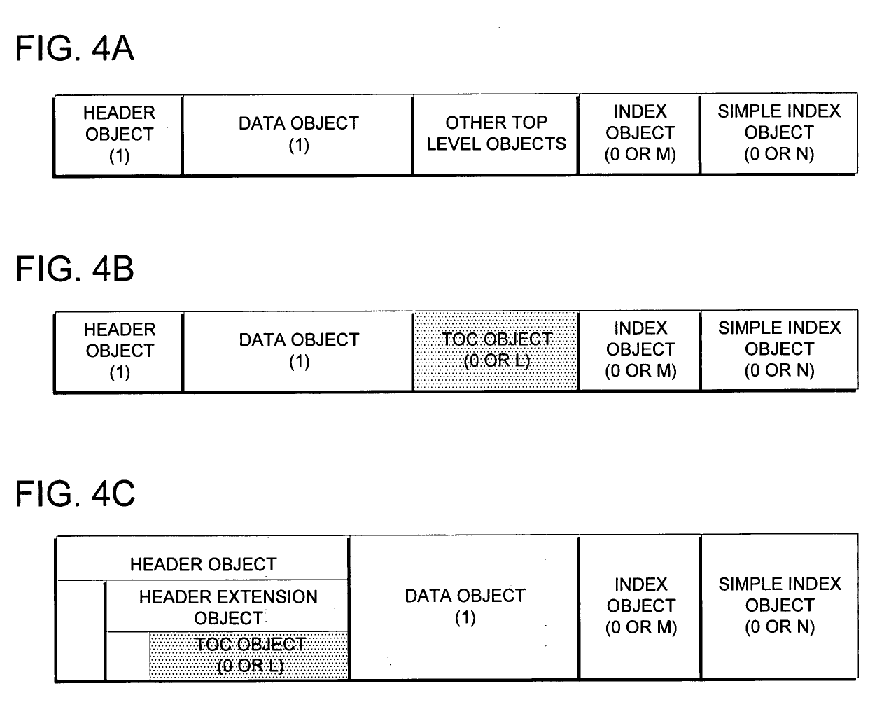

FIG. 4A illustrates an exemplary structure of an ASF file. As shown, a typical ASF file includes a Header object, a Data object, an Index object and a Simple Index object. In addition, all other top level objects are added between the ASF file's Data and Index objects. According to the ASF specification, implementations should ignore any standard or non-standard object that they do not know how to handle.

Those skilled in the art are familiar with a User Defined Index (UDI) object for adding content-based indexing functionality to ASF files. However, the UDI object has several limitations. For example, the ASF specification requires any new top level objects to be inserted between the Data object and the Index object. Because the UDI object is appended to the end of an ASF file, the indexing functionality may not work with all parsers or on all devices. Also, the UDI object does not support hierarchical indices and all per-entry metadata has the same fixed size. Due to these limitations, the UDI object is inadequate for exposing clips 104 via the operating system's shell.

In one embodiment of the invention, the TOC object and CDD descriptors comply with the ASF formatting guidelines, namely, all structures have 1 byte packing, all references to Unicode strings imply a null-terminated string, and objects and structures are stored in little-endian order. The basic data types (and size) include: BYTE (8 bits); WCHAR (16 bits); WORD (16 bits); DWORD (32 bits), QWORD (64 bits); and GUID (128 bits). The TOC object is placed either between the Data object and the Index Object as shown in FIG. 4B or inside the Header Extension object in an ASF file as shown in FIG. 4C. There can be multiple instances of the TOC Object in an ASF file (e.g., one that mimics the Table of Contents typically found at the front of a book; one that mimics the Indices typically found at the end of a book; one per media stream, etc.).

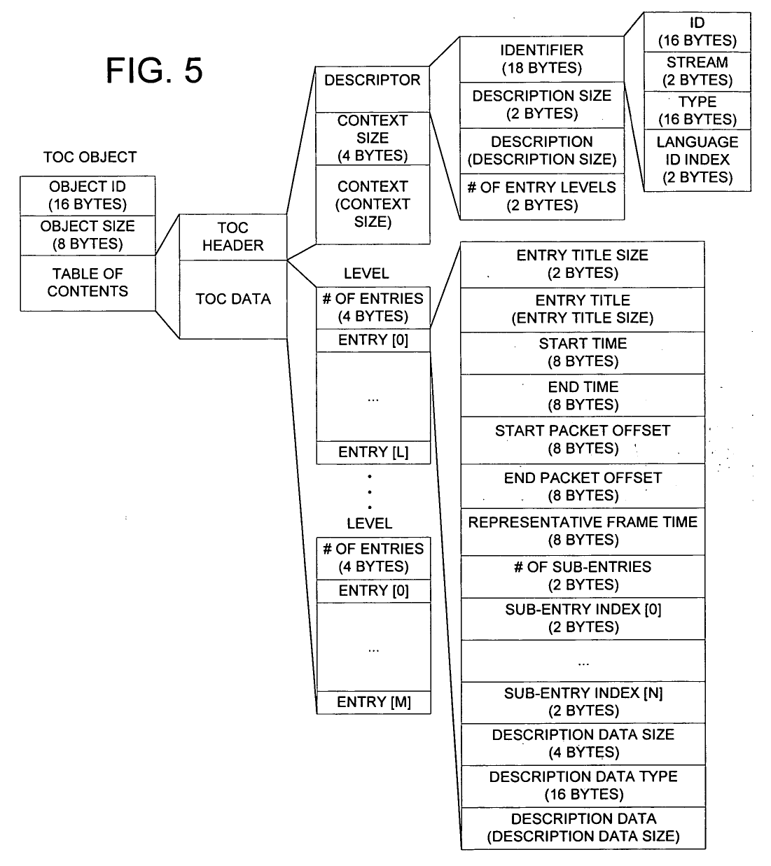

FIG. 5 shows an exemplary layout of the TOC object embodying aspects of the invention.

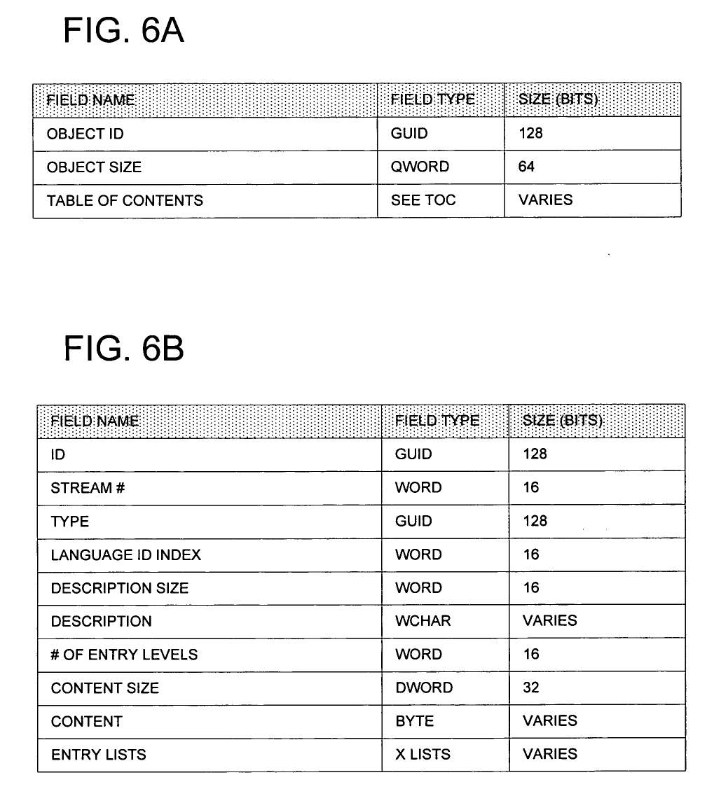

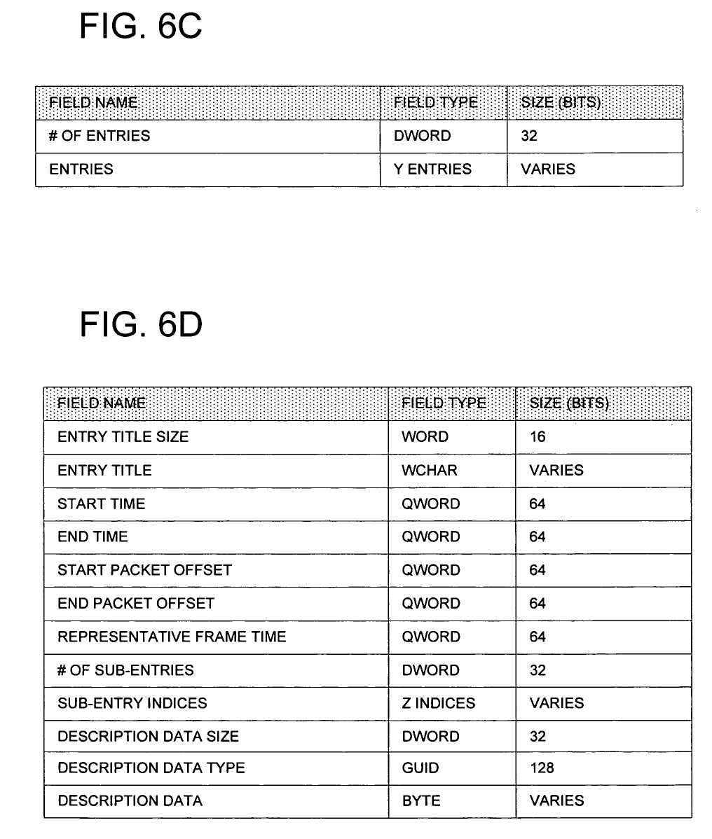

Referring now to FIG. 6A, the TOC Object may be represented using the illustrated structure. In this instance, the Object ID field specifies the GUID for the TOC object (e.g., 35003B7B-A104-4c33-A9EE-E2A240431F9B) and the Object Size field specifies the size, in bytes, of the TOC object. Valid values for the Object Size are, for example, at least 70 bytes. The Table of Contents field of the TOC Object may represented by the structure of FIG. 6B.

In FIG. 6B, the Table of Contents field of the TOC object includes: an ID specifying the unique identifier for this Table of Contents; a Stream # field specifying the media stream # related to this Table of Contents; and a Type field specifying the type of this Table of Contents. In one embodiment, the Type field may be one of the following pre-defined GUIDs shown in TABLE 2 or any other user-defined GUID.

TABLE II

| | |
|---|---|
| ASF_TOC_Type_Playlist | ACC8DAA6-9D06-42d6-8704- |
| | 2B2CA8E1FD9A |
| ASF_TOC_Type_Editlist | 2F133F06-0701-49f9-AD38- |
| | 602F00A7882D |
| ASF_TOC_Type_User_Book | 7A0D993C-C1B0-473b-A048- |
| marks | 2A0DE74E93A5 |
| ASF_TOC_Type_DSP_Meta | 1AEDA271-281D-43ac-8735- |
| data | 8911D408FBCD |

The Table of Contents field of the TOC object shown in FIG. 6B also includes: a Language ID Index field specifying the language, if any, that this Table of Contents uses or assumes; a Description Size field specifying the size, in bytes, of the Description field; a Description field containing textual description of this Table of Contents; a # of Entry Levels field specifying the number of levels of the entry hierarchy; a Context Size field specifying the size, in bytes, of the Context field; a Context field containing any additional description data for this table (its size is determined by the Context Size field); and an Entry Lists field consisting of X lists of Entries where X=# of Entry Levels.

Each Entry List field may be represented using the structure illustrated in FIG. 6C. As shown, one embodiment of the Entry List field includes a # of Entries field specifying the number of Entries existing in this list and an Entries field consisting of Y Entries where Y=# of Entries. FIG. 6D provides an exemplary structure for each Entry field. In this instance, the Entry field includes: an Entry Title Size field specifying the size, in bytes, of the Entry Title field; an Entry Title field specifying the title for this Entry (its size is determined by the Entry Title Size field); a Start Time field specifying the start presentation time for this Entry, in 100-nanosecond units; an End Time field specifying the end presentation time for this Entry, in 100-nanosecond units (set to 0 if not specified); a Start Packet Offset field specifying the byte offset from the start of the first Data Packet in the ASF file to the start of the first Data Packet of this Entry (note that for video streams that contain both key frames and non-key frames, this field will correspond to the closest key frame prior to the time interval); an End Packet Offset field specifying the byte offset from the start of the first Data Packet in the ASF file to the start of the last Data Packet of this Entry (set to 0 if not specified); a Representative Frame Time field specifying the presentation time of a representative frame for this Entry, in 100-nanosecond units; a # of Sub-Entries field specifying the number of sub-entries (i.e., children) under this Entry (set to 0 if this entry has no sub-entries; a Sub-Entry Indices field consisting of Z Sub-Entry Indices where Z=# of Sub-Entries (each Sub-Entry Index is a WORD and contains the position of the corresponding child Entry in the next level Entry List); a Description Data Size field specifying the size, in bytes, of the Description Data (set to 0 if this Entry has no additional description data); a Description Data Type field specifying the type of the Description Data (when Description Data Size is 0, this field will not exist); a Description Data field containing any additional description data about this Entry (its size is determined by the Description Data Size). In one embodiment, the Description Data must belong to a predefined Description Data Type. A Description Data Type may be defined by anyone at anytime as long as the authoring application and the targeted client applications share the type definition and all know how to parse the data.

Exposing clips 104 in the shell via the TOC object and its accompanying metadata enables users to perform tasks that were previously not possible. Once a user can have stored video memories in a media library on the computer exposed by the shell, the user can, for example, easily make a DVD containing every birthday party for his or her daughter from 2001-2004 just by browsing around her birthday in each year on a date-ordered view of clips. In another example, the user can easily query for all 5-star rated family video clips and photographs for making a “best of the year” disc to send out with holiday greetings. The user can perform such tasks either directly without using a video editing program or can launch into the program, passing it all the assets the wants for a particular project.

Another example is e-mailing a video clip to another user. Using presently available software, sending a video clip by e-mail is an editing task. Users need a video editor that can trim video. Such a program requires multiple time consuming steps. By exposing clips 104 in the shell according to embodiments of the invention, once the user has captured a videotape into the user's library, sending a particular video clip 104 from the library is as easy as sending a photo.

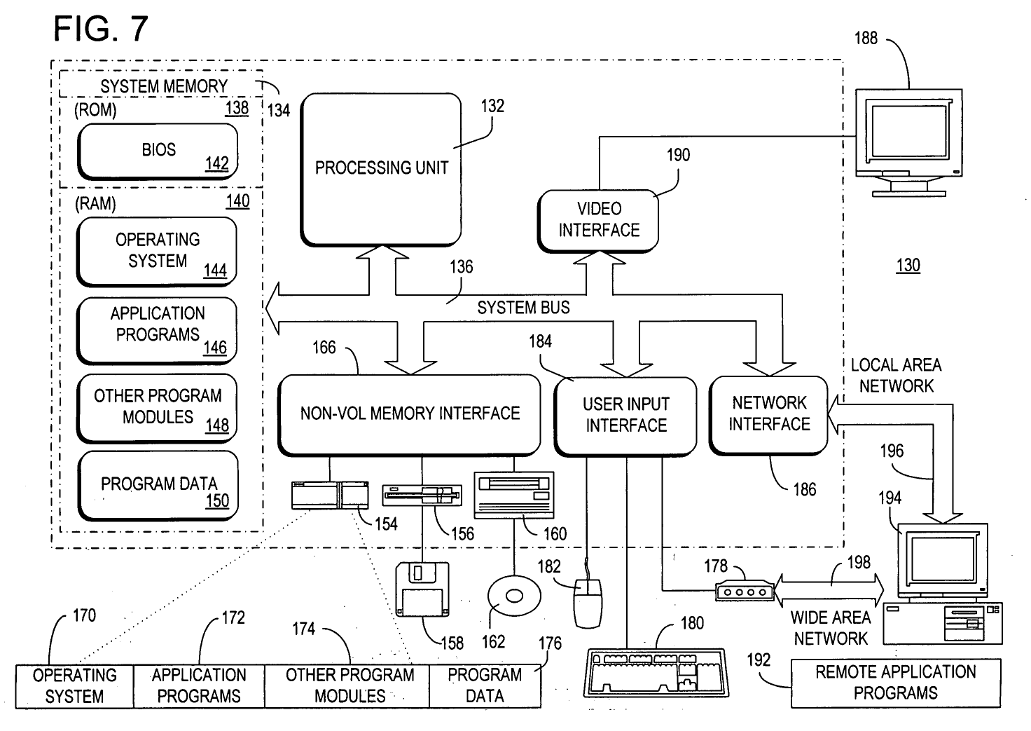

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), including the basic routines that help to transfer information between elements within computer 130, such as during start-up, is typically stored in ROM 138. RAM 140 typically includes data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 7 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Embodiments of the invention described herein include these and other various types of computer-readable storage media when such media include instructions or programs for implementing the steps described below in conjunction with a microprocessor or other data processor. One embodiment of the invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, one embodiment of the invention is operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that may be suitable for use with the embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Embodiments of the invention may also be practiced in distributed computing environments where tasks are performed by remote processing devices that are linked through a communications network. In a distributed computing environment, program modules may be located on both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

Herein, “digital data” of a digital collection is any type of independently addressable unit of digital data which is typically stored within a computer memory or storage system. Examples of such a “digital data” include (but are not limited to): music, image, video, text documents, hypertext document, documents of any format, applications, spreadsheets, graphics, playlists, and data. Digital data may include a collection of other items.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of embodiments of the invention, it is intended that all matter contained in the above description and shown in the accompanying drawings shall be interpreted as illustrative and not in a limiting sense.

What is claimed is:

1. A method of managing one or more digital video files on a computer, said method comprising:
defining at least one video clip from each of the video files to be managed;
assigning metadata representative of the video clip;
storing the metadata in a media file system object, said object being stored in a media library on the computer; and
exposing the object with the metadata to a user via the library.

2. The method of claim 1, further comprising capturing the video file from a video source.

3. The method of claim 1, wherein the computer executes an operating system and a shell interface associated therewith, said shell interface including the media library and enabling management of the video clip directly via the operating system.

4. The method of claim 3, wherein exposing the object comprises retrieving the object from the media library via the shell in response to a user query.

5. The method of claim 1, wherein exposing the object comprises permitting at least one operation on the video clip without altering the video file.

6. The method of claim 5, wherein the operation on the video clip comprises one or more of the following: playback, delete, trim, and combine.

7. The method of claim 1, wherein defining the video clip comprises analyzing the video file for one or more of the following characteristics: recording start time; recording stop time; time code gaps; frame color attributes; image steadiness; and recording duration.

8. The method of claim 1, further comprising rendering the clip to the user directly via the library.

9. The method of claim 1, further comprising modifying the metadata stored in the object in response to user input independent of the video file.

10. The method of claim 9, wherein said user input includes an instruction for editing the video clip.

11. The method of claim 10, wherein the instruction for editing the video clip includes an adjustment to either a mark-in location of the clip or a mark-out location of the clip, or both, for trimming the video clip.

12. The method of claim 1, wherein the metadata comprises one or more of the following: entry-based textual description; cover art, a thumbnail, audiovisual DSP properties; and cross references.

13. The method of claim 1, wherein the object comprises one or more of the following fields: ID; Stream #; Type; Language ID Index; Description Size; Description; # of Entry Levels; Context Size; Context; and Entry Lists.

14. The method of claim 1, wherein the object comprises at least one entry list field, said entry list field further comprising one or more of the following fields: # of Entries; Entries; Entry Title Size; Entry Title; Start Time; End Time; Start Packet Offset; End Packet Offset; Representative Frame Time; # of Sub-Entries; Sub-Entry Indices; Description Data Size; Description Data Type; and Description Data.

15. The method of claim 1, wherein one or more computer-readable media have computer-executable instructions for performing the method recited in claim 1.

16. A computer-readable medium having computer-executable instructions for managing one or more digital video files on a computer, said computer-readable medium comprising:
media file system object for storing metadata representative of a video clip, said video clip comprising a segment of a video file to be managed; and
a shell interface associated with an operating system of the computer, said shell interface exposing the object to enable management of the video clip directly via the operating system.

17. The computer-readable medium of claim 16, further comprising a query component for retrieving the object via the shell thereby exposing the object.

18. The computer-readable medium of claim 16, further comprising an editing component for performing at least one operation on the video clip without altering the video file, said operation comprising one or more of the following: playback, delete, trim, and combine.

19. The computer-readable medium of claim 16, further comprising an updated media file system object for storing modified representative of an edited video clip independent of the video file.

20. The computer-readable medium of claim 16, wherein the metadata comprises one or more of the following: entry-based textual description; cover art, a thumbnail, audiovisual DSP properties; and cross references.
